(19) United States
(12) Patent Application Publication
(10) Pub. No.: US 2022/0306011 A1
(43) Pub. Date: Sep. 29, 2022

(54) FRAME ON CARRIER FOR AUTO INTERIOR COVER GLASS APPLICATIONS

(71) Applicant: CORNING INCORPORATED, CORNING, NY (US)

(72) Inventors: Gaurav Dave, Painted Post, NY (US); Khaled Layouni, Fontainebleau (FR); Kenneth Spencer Morgan, Painted Post, NY (US); Michael William Price, Corning, NY (US); Wendell Porter Weeks, Corning, NY (US); Wei Xu, Horseheads, NY (US)

(21) Appl. No.: 17/616,881

(22) PCT Filed: Jun. 1, 2020
(86) PCT No.: PCT/US2020/035498

§ 371 Date: Dec. 6, 2021

Related U.S. Application Data
(60) Provisional application No. 62/858,664, filed on Jun. 7, 2019.

(51) Int. Cl. B60R 11/02; B60K 37/04

(52) U.S. Cl. CPC B60R 11/0229; B60K 37/04; B60K 2370/1523; B60K 2370/693

(57) ABSTRACT

Disclosed herein are embodiments of a curved glass article. The curved glass article includes a glass sheet having a first major surface and a second major surface. The second major surface is opposite to the first major surface, and the first major surface and the second major surface define a thickness therebetween. The curved glass article also includes a carrier having a curvature and being made of a carrier material. The carrier material has a coefficient of thermal expansion (CTE) of from 8(10⁻⁶)/° C. to 40(10⁻⁶)/° C. The glass sheet is adhered to the carrier such that the glass sheet conforms to the curvature of the carrier.

### CROSS-REFERENCE TO RELATED APPLICATIONS

This application claims the benefit of priority under 35 U.S.C. § 119 of U.S. Provisional Application Ser. No. 62/858,664 filed on Jun. 7, 2019 the content of which is relied upon and incorporated herein by reference in its entirety.

### BACKGROUND

The disclosure relates to glass articles and methods for forming same, and more particularly to vehicle interior systems including a glass article with carrier having a coefficient of thermal expansion closely matching that of the glass sheet.

Vehicle interiors include curved surfaces and can incorporate displays in such curved surfaces. The materials used to form such curved surfaces are typically limited to polymers, which do not exhibit the durability and optical performance as glass. As such, curved glass substrates are desirable, especially when used as covers for displays. Existing methods of forming such curved glass substrates, such as thermal forming, have drawbacks including high cost, optical distortion, and surface marking. Accordingly, Applicant has identified a need for vehicle interior systems that can incorporate a curved glass substrate in a cost-effective manner and without problems typically associated with glass thermal forming processes.

### SUMMARY

According to an aspect, embodiments of the disclosure relate to a curved glass article. The curved glass article includes a glass sheet having a first major surface and a second major surface. The second major surface is opposite to the first major surface, and the first major surface and the second major surface define a thickness therebetween. The curved glass article also includes a carrier having a curvature and being made of a carrier material. The carrier material has a coefficient of thermal expansion (CTE) of from 8(10⁻⁶)/° C. to 40(10⁻⁶)/° C. The glass sheet is adhered to the carrier such that the glass sheet conforms to the curvature of the carrier.

According to another aspect, embodiments of the disclosure relate to a curved glass article. The curved glass article includes a glass sheet comprising a first major surface and a second major surface in which the second major surface is opposite to the first major surface. The first major surface and the second major surface define a thickness therebetween. The curved glass article also includes a carrier comprising a curvature and an adhesive bonding the second major surface of the glass sheet to the carrier such that the glass sheet conforms to the curvature of the carrier. The adhesive has a bonding strength. A combined stress includes a bending stress to conform the glass sheet to the curvature and a shear stress caused by a differential in expansion resulting from heating the glass sheet and carrier up by 75° from room temperature. The combined stress is less than the bonding strength.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a vehicle interior with vehicle interior systems, according to exemplary embodiments;

FIGS. 2A and 2B depict a side view and a rear view, respectively, of a V-shaped glass article, according to an exemplary embodiment;

FIGS. 3A and 3B depict a side view and a rear view, respectively, of a C-shaped glass article, according to an exemplary embodiment;

FIG. 4 depicts a graph of shear stress in adhesive as a function of the carrier coefficient of thermal expansion (CTE), according to an exemplary embodiment;

FIG. 5 depicts a graph of the CTE of a composite material as compared to glass CTE, according to an exemplary embodiment;

FIG. 6 depicts a graph of tensile stress and shear stress in the adhesive as a function of the CTE of the carrier material, according to an exemplary embodiment;

FIG. 7 schematically represents the stresses in the adhesive graphed in FIG. 6, according to an exemplary embodiment;

FIG. 8 depicts a graph of deflection as a function of carrier height for a stainless steel and a composite carrier, according to an exemplary embodiment;

FIGS. 9 and 10 depict prototypes of carriers, according to an exemplary embodiment;

FIGS. 11A-11C depict an embodiment of a segmented strip carrier, according to an exemplary embodiment;

FIGS. 12A-12C depict another embodiment of a segmented strip carrier, according to an exemplary embodiment;

FIGS. 13A-13C depict an embodiment of a carrier as provided on a V-shaped glass article, according to an exemplary embodiment;

FIGS. 14A and 14B depict an embodiment of a carrier as provided on a C-shaped glass article, according to an exemplary embodiment;

FIGS. 15A and 15B depict the carrier of FIGS. 14A and 14B as installed on a frame of a vehicle interior system, according to an exemplary embodiment; and

FIG. 16 depicts a glass sheet suitable for cold-forming on a carrier to produce a glass articles, according to an exemplary embodiment.

### DETAILED DESCRIPTION

Reference will now be made in detail to various embodiments, examples of which are illustrated in the accompanying drawings. In general, the various embodiments pertain to vehicle interior systems having curved glass surfaces. In the embodiments discussed herein, the curved glass surfaces comprise a glass sheet bonded to a carrier that holds the glass in its curved shape. Further, the carrier is configured to be mounted to a frame of an automotive interior system. Advantageously, the carrier defines a bezel (i.e., a non-display region) that is at most about 10 mm in width, more particularly at most about 2 mm in width, leaving a large majority of the glass surface available for viewing a rear-mounted display. The carrier is able to be so small and have such a small bezel width because the stresses between the cold-bent glass and the carrier are optimized such that the possibility of the glass sheet debonding from the carrier is substantially reduced. In particular, the coefficient of thermal expansion (CTE) of the carrier is matched to the CTE of the glass such that the thermal stress component of the total stress between the glass sheet and carrier does not cause the glass sheet to shear the adhesive binding the glass sheet to the carrier. Various embodiments of the carrier and configurations for mounting the carrier to a vehicle frame are disclosed herein. These embodiments are provided by way of illustration and not by way of limitation.

In general, a vehicle interior system may include a variety of different curved surfaces that are designed to be transparent, such as curved display surfaces and curved non-display glass covers. Forming curved vehicle surfaces from a glass material provide a number of advantages compared to the typical curved plastic panels that are conventionally found in vehicle interiors. For example, glass is typically considered to provide enhanced functionality and user experience in many curved cover material applications, such as display applications and touch screen applications, compared to plastic cover materials.

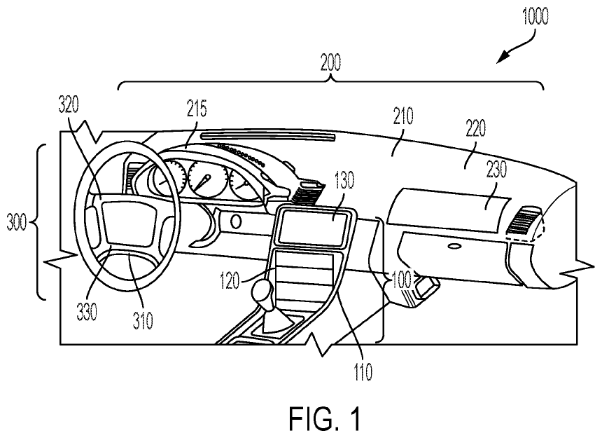

FIG. 1 shows an exemplary vehicle interior 1000 that includes three different embodiments of a vehicle interior system 100, 200, 300. Vehicle interior system 100 includes a frame, shown as center console base 110, with a curved surface 120 including an optically bonded display 130. Vehicle interior system 200 includes a frame, shown as dashboard base 210, with a curved surface 220 including an optically bonded display 230. The dashboard base 210 typically includes an instrument panel 215 which may also include an optically bonded display. Vehicle interior system 300 includes a frame, shown as steering wheel base 310, with a curved surface 320 and an optically bonded display 330. In one or more embodiments, the vehicle interior system includes a frame that is an arm rest, a pillar, a seat back, a floor board, a headrest, a door panel, or any portion of the interior of a vehicle that includes a curved surface. In other embodiments, the frame is a portion of a housing for a free-standing display (i.e., a display that is not permanently connected to a portion of the vehicle). In embodiments, the optically bonded display 130, 230, 330 is at least one of a light emitting diode (LED) display, an organic LED (OLED) display, a liquid crystal display (LCD), or plasma display

The embodiments of the glass article described herein can be used in each of vehicle interior systems 100, 200 and 300. Further, the glass articles discussed herein may be used as curved cover glasses for any of the display embodiments discussed herein, including for use in vehicle interior systems 100, 200 and/or 300. Further, in various embodiments, various non-display components of vehicle interior systems 100, 200 and 300 may be formed from the glass articles discussed herein. In some such embodiments, the glass articles discussed herein may be used as the non-display cover surface for the dashboard, center console, door panel, etc. In such embodiments, glass material may be selected based on its weight, aesthetic appearance, etc. and may be provided with a coating (e.g., an ink or pigment coating) with a pattern (e.g., a brushed metal appearance, a wood grain appearance, a leather appearance, a colored appearance, etc.) to visually match the glass components with adjacent non-glass components. In specific embodiments, such ink or pigment coating may have a transparency level that provides for deadfront or color matching functionality.

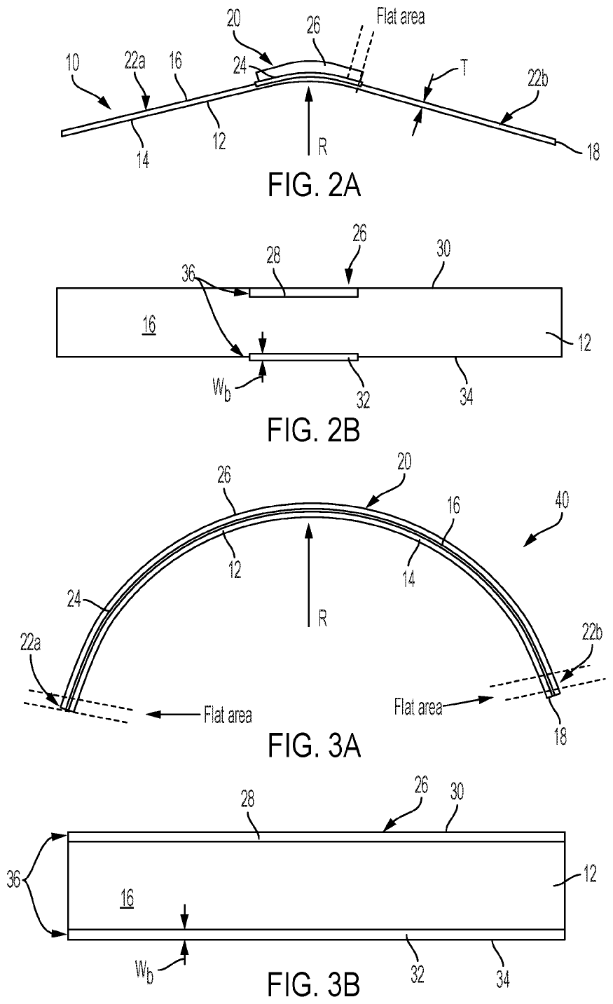

In embodiments, the curved surfaces 120, 220, 320 are generally either V-shaped as shown in FIGS. 2A and 2B or C-shaped as shown in FIGS. 3A-3B. Referring first to FIG. 2A, a side view of an embodiment of a V-shaped article 10 is shown. The V-shaped glass article 10 includes a glass sheet 12. The glass sheet 12 has a first major surface 14 and a second major surface 16. In a vehicle, the first major surface 14 faces the occupants of the vehicle, and the second major surface 16 is the rear surface of the V-shaped glass article 10 to which a display (e.g., an LED display, OLED display, LCD display, or a plasma display) may be mounted, e.g., using an optically clear adhesive. The second major surface 16 is opposite to the first major surface 14, and the first major surface 14 and the second major surface 16 define a thickness T of the glass sheet 12. The first major surface 14 and the second major surface 16 are joined by a minor surface 18.

As can be seen in FIG. 2A, the glass sheet 12 has a curved region 20 disposed between a first flat section 22a and a second flat section 22b. In embodiments, the curved region 20 has a radius of curvature R that is from 20 mm to 10 m. Further, as shown in FIG. 2A, the curved region 20 defines a concave curve, but in other embodiments, the curved region 20 is instead a convex curve. For the V-shaped article 10 of FIG. 2A, an adhesive 24 is applied on the second major surface 16 in the curved region 20. The adhesive 24 attaches a carrier 26 to the glass sheet 12.

In embodiments, the adhesive 24 comprises a pressure sensitive adhesive. Exemplary pressure sensitive adhesives suitable for use in the adhesive 24 include at least one of 3M™ VHB™ (available from 3M, St. Paul, Minn.) or Tesa® (available from tesa SE, Norderstedt, Germany). In embodiments, the adhesive 24 comprises a liquid adhesive. Exemplary liquid adhesives include toughened epoxy, flexible epoxy, acrylics, silicones, urethanes, polyurethanes, and silane modified polymers. In specific embodiments, the liquid adhesive includes one or more toughened epoxies, such as EP21TDCHT-LO (available from Masterbond®, Hackensack, N.J.), 3M™ Scotch-Weld™ Epoxy DP460 Off-White (available from 3M, St. Paul, Minn.). In other embodiments, the liquid adhesive includes one or more flexible epoxies, such as Masterbond EP21TDC-2LO (available from Masterbond®, Hackensack, N.J.), 3M™ Scotch-Weld™ Epoxy 2216 B/A Gray (available from 3M, St. Paul, Minn.), and 3M™ Scotch-Weld™ Epoxy DP125. In still other embodiments, the liquid adhesive includes one or more acrylics, such as LORD® Adhesive 410/Accelerator 19 w/LORD® AP 134 primer, LORD® Adhesive 852/LORD® Accelerator 25 GB (both being available from LORD Corporation, Cary, N.C.), DELO PUR SJ9356 (available from DELO Industrial Adhesives, Windach, Germany), Loctite® AA4800, Loctite® HF8000. TEROSON® MS 9399, and TEROSON® MS 647-2C (these latter four being available from Henkel AG & Co. KGaA, Dusseldorf, Germany), among others. In yet other embodiments, the liquid adhesive includes one or more urethanes, such as 3M™ Scotch-Weld™ Urethane DP640 Brown and 3M™ Scotch-Weld™ Urethane DP604, and in still further embodiments, the liquid adhesive includes one or more silicones, such as Dow Corning® 995 (available from Dow Corning Corporation, Midland, Mich.).

Further, in embodiments, a primer can be applied to prepare the surfaces of the glass sheet 12 and carrier 26 for better adhesion. Additionally to or instead of applying the primer, carrier 26 may be roughened, in embodiments, to provide better adhesion between the adhesive 24 and the carrier 26. Further, in embodiments, an ink primer may be used in addition to or instead of the primer for metal and glass surfaces. The ink primer helps provide better adhesion between the adhesive 24 and ink covered surfaces (e.g., the pigment design mentioned above for deadfronting applications). An example of a primer is 3M™ Scotch-Weld™ Metal Primer 3901 (available from 3M, St. Paul, Minn.); other commercially available primers are also suitable for use in the present disclosure and can be selected based on surfaces involved in the bonding and on the adhesive used to create the bond.

Via the adhesive 24 and a cold-forming process (as described below), the carrier 26 holds the glass sheet 12 in the curved shaped. The carrier 26 is also configured to be attached to a frame of a vehicle interior system, such as the vehicle interior systems 100, 200, 300 of FIG. 1. As shown in FIG. 2B, the carrier 26 has a height H corresponding to the distance that the carrier 26 extends from the adhesive 24. In embodiments, the height H is from 5 mm to 20 mm, more particularly from 8 mm to 12 mm.

FIG. 2B shows the rear surface, i.e., the second major surface 16, of the V-shaped glass article 10. As shown in FIG. 2B, the carrier 26 comprises a first strip 28 on a first lateral side 30 of the glass sheet 12, and a second strip 32 on a second lateral side 34 of the glass sheet 12. In embodiments, the strips 28, 32 of the carrier 26 are applied across the width of the curved region 20, and in embodiments, the carrier 26 may extend into the flat sections 22a, 22b as shown in FIG. 2A. As can be seen in FIG. 2B, the glass sheet 12 is substantially unobstructed by the carrier 26. In particular embodiments, the carrier 26 defines a bezel 36 over a portion of the glass sheet 12. As used herein, “bezel” refers to the amount of the glass sheet 12 that cannot be used for viewing a display (e.g., a display mounted to the second major surface 16). In embodiments, the width W_{b} of the bezel 36 is at most 10 mm, more particularly at most 5 mm and most particularly at most 2 mm.

FIG. 3A depicts an embodiment of a C-shaped glass article 40. The C-shaped glass article 40 also includes a glass sheet 12. As with the V-shaped glass article 10 of FIGS. 2A and 2B, the glass sheet 12 of the C-shaped glass article 40 of FIG. 3A has a first major surface 14 and a second major surface 16 defining a thickness T and being joined by a minor surface 18. The C-shaped glass article 40 also has a curved region 20 and flat sections 22a, 22b. As compared to the V-shaped glass article 10, the C-shaped glass article 40 has a much larger curved region 20 and much smaller flat sections 22a, 22b. As can be seen in FIG. 3A, the carrier 26 is attached to the second major surface 16 with the adhesive 24. Because the curved region 20 is much larger than in the previously discussed embodiment, the carrier 26 extends substantially along the entirety of each lateral sides 30, 34 as shown in FIG. 3B. However, the bezel 36 defined by the strips 28, 32 of the carrier 26 remains at most 10 mm, more particularly at most 5 mm and most particularly at most 2 mm.

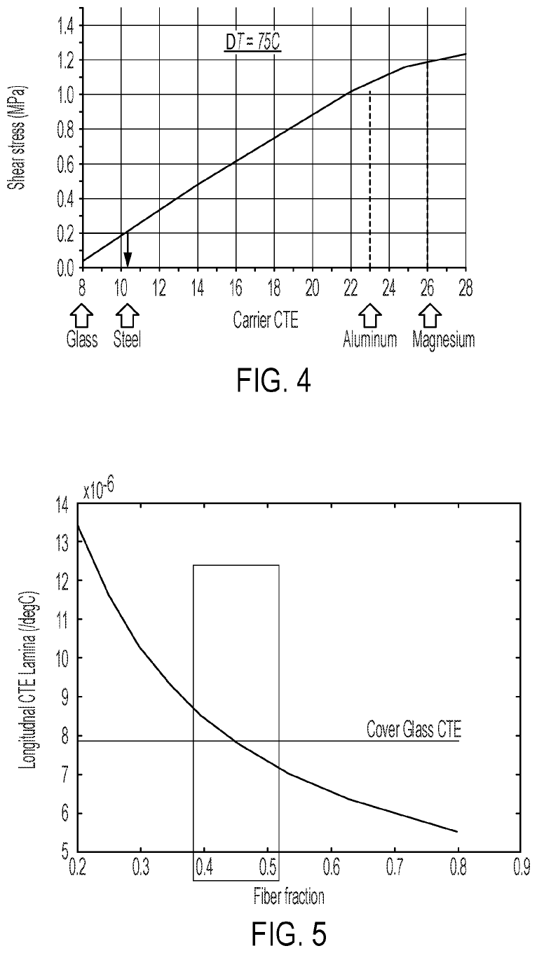

As mentioned above, the carriers 26 of both the V-shaped glass article 10 and the C-shaped glass article 40 are made from a material having a CTE that matches the CTE of the glass sheet 12. The matching CTE reduces the thermal stress developed in the adhesive 24 as a result of thermal expansion differences between the glass sheet 12 and the carrier 26. FIG. 4 depicts a graph of the shear stress developed in the adhesive 24 as a function of the CTE of the carrier 26. The glass sheet 12 has a CTE of approximately 8(10⁻⁶)/° C. Thus, in embodiments, the carrier 26 is selected to have a CTE of between about 8(10⁻⁶)/° C. and about 40(10⁻⁶)/C more particularly between about 8(10⁻⁶)/° C. and about 22(10⁻⁶)/° C., even more particularly between about 8(10⁻⁶)/° C. and about 15(10⁻⁶)/° C., and most particularly between about 8(10⁻⁶)/° C. and about 15(10⁻⁶)/° C.

As shown in FIG. 4, the shear stress in the adhesive increases as the CTE increases further from the glass CTE. For example, a carrier 26 of aluminum or magnesium has a CTE of 23(10⁻⁶)/° C. or 26(10⁻⁶)/° C., respectively, and the shear stress produced at a temperature change of 75° C. is about 1 MPa and 1.2 MPa, respectively. A carrier 26 of steel has a CTE of about 10(10⁻⁶)/° C., and the shear stress produced at a temperature change of 75° C. is about 0.2 MPa. A temperature change of 75° C. was used because, in general, the minimum temperature for thermal reliability testing in the automotive industry is 95° C., which is a temperature change of 75° C. from room temperature (20° C.). Based on the carrier material chosen, the adhesive is selected to be able to withstand the combined shear stress and bending stress. Thus, in embodiments, the adhesive 24 used with an aluminum or magnesium carrier 26 would need to have a higher bonding strength than an adhesive used with a steel carrier 26.

Table 1, below, considers various carrier materials as used in combination with an adhesive having a bonding strength of 0.6 MPa.

| | Young's | CTE | Shear | | |
|---|---|---|---|---|---|
| | Modulus | (10⁻⁶)/ | Stress | Stress < | |
| Material | (GPa) | ° C. | (MPa) | Strength | Cost |
| Kovar | 210 | 8.00 | 0.03 | Yes | High |
| Stainless | 210 | 10.5 | 0.22 | Yes | Medium |
| Steel 430 | | | | | |
| Stainless | 210 | 12.8 | 0.39 | Yes | Medium |
| Steel | | | | | |
| Aluminum | 69 | 21.8 | 1.00 | No | Medium |
| Magnesium | 45 | 24.8 | 1.16 | No | Medium |
| Plastics | 4 | 70.0 | 2.2 | No | Low |

In preparing Table 1, certain assumptions were made. The total stress on the adhesive was estimated to be the sum of the bending stress to keep the glass sheet bent in conformity with the carrier and the shear stress caused by the mismatch in the CTE between the glass sheet 12 and the carrier 26. For bending stress, the C-shaped glass article 40 has the larger bending stress because of the larger curved region 20. The maximum bending stress for the C-shaped glass article 40 was estimated as being the maximum glass bending force divided by the area with a 1 mm bezel 36. The maximum bending force was calculated to be 200 N and the area was 1000 mm², and thus, the maximum bending stress was 0.2 MPa. The maximum bending stress of the V-shaped bending article 10 can be assumed to be lower than 0.2 MPa because of the smaller curved region 20. The shear stress was calculated for a temperature change of 75° C. and is shown in the fourth column of Table 1. The estimation of total stress therefore is the 0.2 MPa bending stress in addition to the shear stress for each material in Table 1. The fifth column of Table 1 considers whether the total stress (Stress) is less than the strength (Strength) of the adhesive. For the purposes of Table 1, the adhesive was assumed to have a strength of 0.6 MPa (which corresponds to the long-term strength of a polyurethane structural adhesive (e.g., BETASEAL™ X2500Plus, available from The Dow Chemical Company, Midland, Mich.)). Based on the fifth column (Stress<Strength), suitable materials for the carrier 26 include Kovar (Fe—Ni—Co alloy) and the two stainless steels tested. The aluminum, magnesium, and plastic carrier materials all produced shear stresses that, when combined with the maximum bending stress, exceeded the long-term strength of the adhesive 24. Thus, in order to use aluminum or magnesium as a carrier, a stronger adhesive would have to be used. The sixth column of Table 1 considers the cost of the material used for the frame. As can be seen, the stainless steels have a cost in range with the conventionally used aluminum and magnesium alloys, indicating that a switch to a stainless steel carrier material is also practical economically.

In embodiments, the carrier 26 can be made of any material having a CTE between 8(10⁻⁶)/° C. and 40(10⁻⁶)/° C. when the adhesive is selected to have a bonding strength greater than the combined shear stress and bending stress. Thus, a variety of metal materials can be used, including steel (especially stainless steel, galvanized steel, and other corrosion-resistant steels), iron-nickel alloys, aluminum and its alloys, and magnesium and its alloys. Further, the carrier material can be a plastic or, as discussed below, a composite material. In this way the carrier material and adhesive can be selected from a wide variety of materials, allowing for design and economic flexibility.

In another embodiment, the carrier material may be a fiber-reinforced plastic composite material. For example, the carrier material may comprise a composite with glass fibers embedded in an epoxy resin. The glass fibers have a Young's modulus of 720 GPa and a CTE of 5(10⁻⁶)/° C. The epoxy resin has a Young's modulus of 35 GPa and a CTE of 57.5(10⁻⁶)/° C. The CTE of the composite material will depend on the relative amounts of glass fiber and epoxy resin. FIG. 5 depicts a graph of the longitudinal CTE for a composite material having various glass fiber fractions. As would be expected of the composite material, the longitudinal CTE decreases as the fiber fraction increases (given that more low CTE material is present). FIG. 5 depicts a zone in which the CTE mismatch of the composite material is acceptable for use with a glass sheet having a CTE of about 8(10⁻⁶)/° C. In embodiments, the acceptable fiber volume fraction is from about 0.38 to 0.52. In embodiments, the fiber component of the composite material comprises at least one of glass fibers, carbon fibers, aramid fibers, or graphite fibers. In embodiments, the plastic component of the composite material comprises at least one of an epoxy resin, polycarbonate, acrylic, polyester, polyetherketoneketone (PEKK), polycarbonate/acrylonitrile butadiene styrene (PC/ABS), polypropylene, or phenolic resin. Further, in embodiments, the fibers may be aligned along a longitudinal axis of the carrier 26, which may be along the lateral sides 30, 34 of the glass sheet 12.

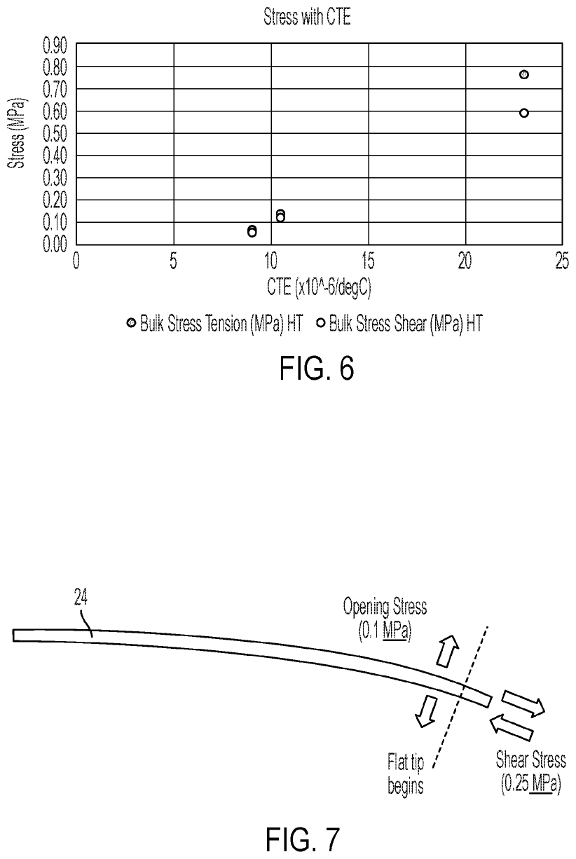

FIG. 6 depicts a graph of the stress as a function of carrier material CTE. In particular, FIG. 6 shows both a bulk stress tension component and a bulk stress shear component. The specific stresses of the adhesive 24 are illustrated in FIG. 7. In FIG. 7, the tension component can be considered an opening stress, i.e., the pull of the glass sheet away from the carrier, which puts tension on the adhesive 24. The shear component is associated with CTE mismatch between glass sheet 12 and carrier 12 that causes shear in the adhesive 24. Returning to FIG. 6, the graph shows that the magnitude of both the tension component and the shear component increase as the CTE of the carrier material increases. The graph of FIG. 6 considers the stresses associated with a glass sheet 12 having a length of 750 mm, a width of 150 mm, a radius of curvature of 2300 mm, and a height H of the carrier 26 of 10 mm.

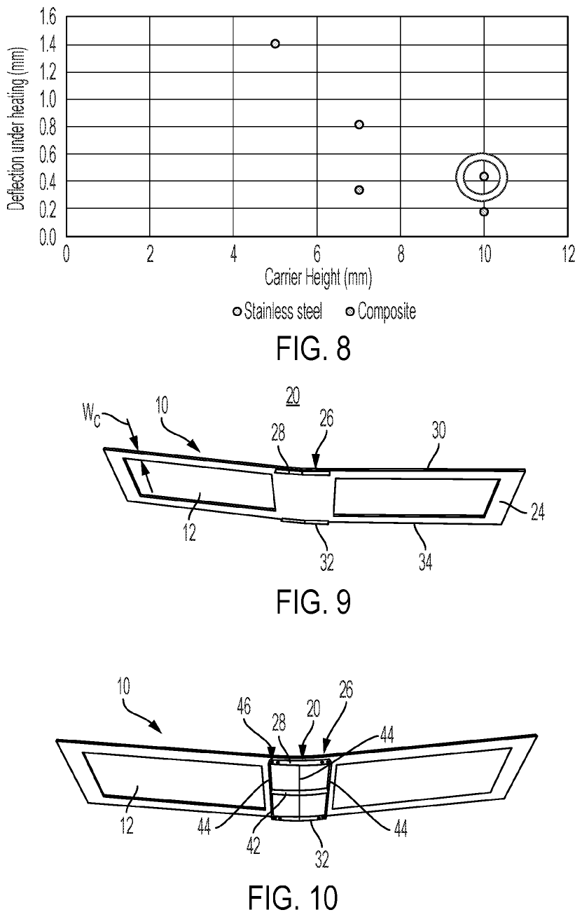

FIG. 8 depicts a graph of the deflection of the glass sheet 12 bonded to the carrier 26 as a function of carrier height H. The deflection relates to the mismatch in CTE between the glass sheet 12 and carrier 26, which results in uneven expansion of the glass sheet 12 and carrier 26 when heated. Because of the uneven expansion, (typically) the carrier 26 will expand more than the glass sheet 12, causing the combination of elements to deflect toward the glass sheet 12. In FIG. 8, this deflection was modeled as a function of carrier height H. As can be seen, the deflection decreases as the carrier height H increases for both a stainless steel and a composite carrier.

FIGS. 9-15 depict various embodiments of the carrier 26 mounted to the glass sheet 12. FIGS. 9 and 10 depict prototype V-shaped glass articles 10. As can be seen in FIG. 9, the V-shaped glass article 10 is substantially similar to what is depicted in FIGS. 2A and 2B. That is the carrier 26 includes a first strip 28 on a first lateral side 30 of the glass sheet 12, and a second strip 32 on a second lateral side 34 of the glass sheet 12. In the embodiment depicted, the V-shaped glass article 10 includes adhesive 24 as it would conventionally be applied to the glass sheet 12 to join a conventional carrier 26 to the glass sheet 12. As can be seen, the adhesive 24 defines a conventional bezel width W_{c} that is larger than required for the carrier 26 according to the present disclosure. Indeed, all of the adhesive not provided under the strips 28, 32 of the carrier 26 can be removed according to embodiments of the present disclosure, substantially increasing the display area of the glass sheet.

FIG. 10 depicts another embodiment of a carrier 26. The carrier 26 includes the first strip 28 and the second strip 32 but also includes a third strip 42 positioned between the first strip 28 and the second strip 32. The carrier 26 also includes a plurality of reinforcing strips 44 that extend from the first strip 28 through the third strip 42 and to the second strip 32. As shown in FIG. 10, there are three reinforcing strips 44. However, in other embodiments, there may more or fewer reinforcing strips 44, e.g., from one to twenty reinforcing strips 44 (for example, positioned periodically over the entire curved region 20 of a C-shaped glass article 40). FIG. 10 also depicts a plurality of apertures 46 formed in the first strip 28 and in the second strip 32. These apertures 46 are configured to receive, e.g., push fasteners to attach the carrier 10 to a frame of a vehicle interior system.

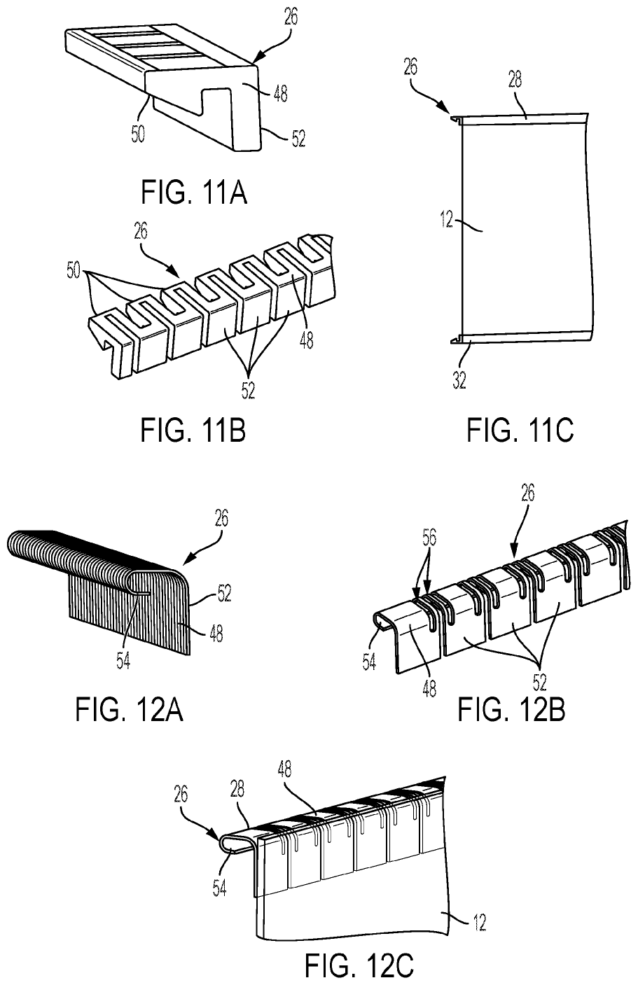

FIGS. 11A-11C depicts another embodiment of the carrier 26. The carrier 26 includes a segmented strip 48 that can be used as either the first strip 28 or the second strip 32 or both the first strip 28 and the second strip 32 (as shown in FIG. 11C). The segmented strip 48 defines a plurality of detents 50 along the length of the segmented strip 48. The segmented strip 48 also defines a plurality of bonding surfaces 52 for adhering the segmented strip 48 to the glass sheet 12. As can be seen in FIG. 11B, the segmented strip 48 has zigzagging structure that allows for different expansion on the side with the detents 50 than on the side with the bonding surfaces 52. Thus, the expansion of the frame of the interior vehicle system is not transferred to the glass sheet 12, or vice versa.

FIGS. 12A-C depict another embodiment of a segmented strip 48 usable as either or both of the first strip 28 and second strip 32 of the carrier 26. The segmented strip 48 includes bonding surfaces 52 for attaching the segmented strip 48 to the glass sheet 12, but the segmented strip of FIGS. 12A-12C also includes a hook member 54 that is configured to engage a corresponding structure of the frame of a vehicle interior system. The segmented strip 48 includes a plurality of slots 56 that allow for differential expansion at the hook member 54 side and at the bonding surface 52 side.

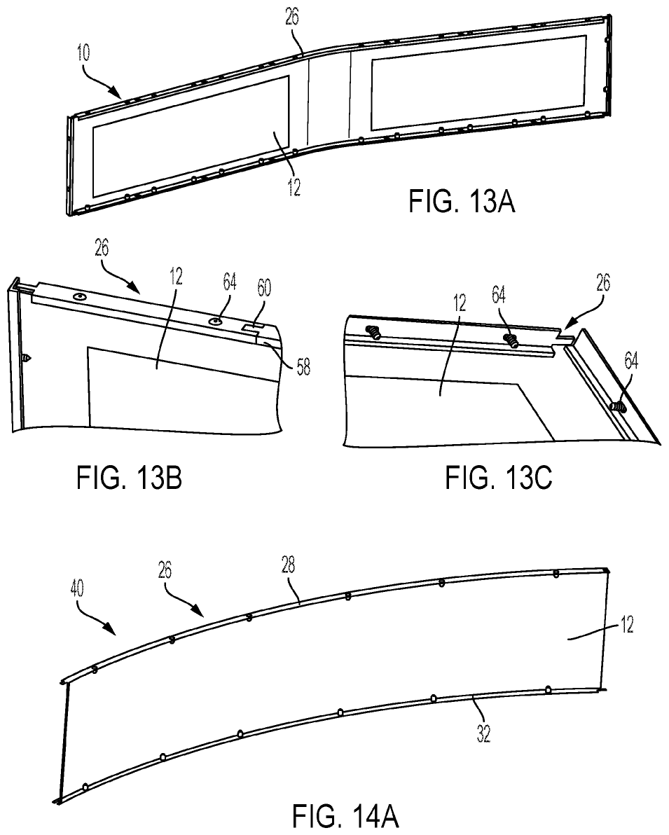

FIGS. 13A-13C depict another embodiment of a carrier 26 on a V-shaped glass article 10 (although, the carrier 26 could also be used with a C-shaped glass article 40). As can be seen in FIG. 13A, the carrier 26 extends substantially around the perimeter of the glass sheet 12. The carrier 26 includes a bonding strip 58 connected to a mounting strip 60. In the embodiment depicted, the bonding strip 58 is arranged substantially (e.g., within 10°) perpendicularly to the mounting strip 60. The bonding strip 58 is configured to be attached to the glass sheet 12 with adhesive 24. In the embodiment of FIGS. 13A-13C, the mounting strip 60 includes a plurality of apertures 62 through which fasteners 64 can be inserted to join the carrier 26 to the frame of a vehicle interior system.

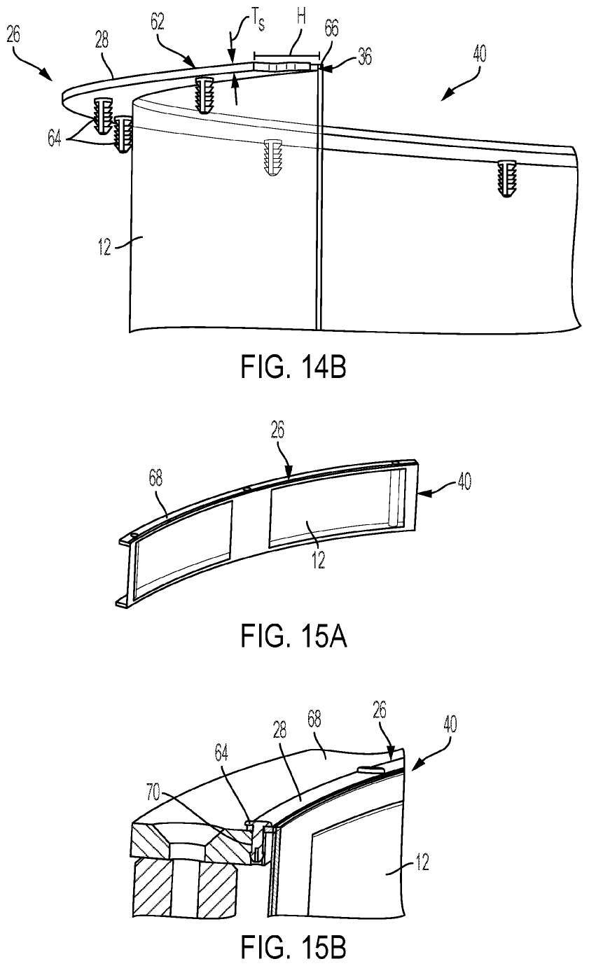

FIGS. 14A and 14B depict another embodiment of a carrier 26 on a C-shaped glass article 40 (although, the carrier 26 could also be used with a V-shaped glass article 10). As shown in FIG. 14A, the carrier 26 includes a first strip 28 and a second strip 32 at the lateral sides 30, 34 of the glass sheet 12. As can be seen in FIG. 14B, an edge 66 of the strip 28 is adhered to the second major surface 16 of the glass sheet 12. FIG. 14B also shows that the height H of the strip 28 greatly exceeds the thickness Ts of the strip 28. As discussed above, a larger height H (e.g., at least 10 mm) reduces the amount of deflection as a result of CTE mismatch, and the small thickness (e.g., less than 2 mm) decreases the bezel 36 of the C-shaped glass article 40. The strip 28 includes a plurality of apertures 62 through which fasteners 64 can be inserted to join the carrier 26 to the frame of a vehicle interior system. FIGS. 15A and 15B depict the carrier 26 of FIGS. 14A and 14 B as installed on a frame 68 of a vehicle interior system. As shown in FIG. 14B, the fasteners 64 inserted through the apertures 62 of the strip 28 engage a corresponding mating hole 70 located in the frame 68.

As mentioned briefly above, the glass sheet 12 is joined to the carrier 26 via cold-forming methods. By cold-forming, it is meant that the curved region 20 is introduced to the glass sheet 12 at a temperature below the softening temperature of the glass. More particularly, cold-forming takes place at below 200° C., below 100° C., or even at room temperature. During cold forming, pressure is applied to the glass sheet 12 to bring the glass sheet 12 into conformity with the shape of the carrier 26. Pressure may be applied in a variety of different ways, such as vacuum pressure, a mechanical press, rollers, etc. In embodiments, pressure is maintained on the glass sheet 12 until the adhesive 24 cures (at least enough to prevent debonding of the glass sheet 12 from the carrier 26). Thereafter, the glass sheet 12 is bonded to the carrier 26, and the glass article may be shipped and/or installed as part of a vehicle interior system.

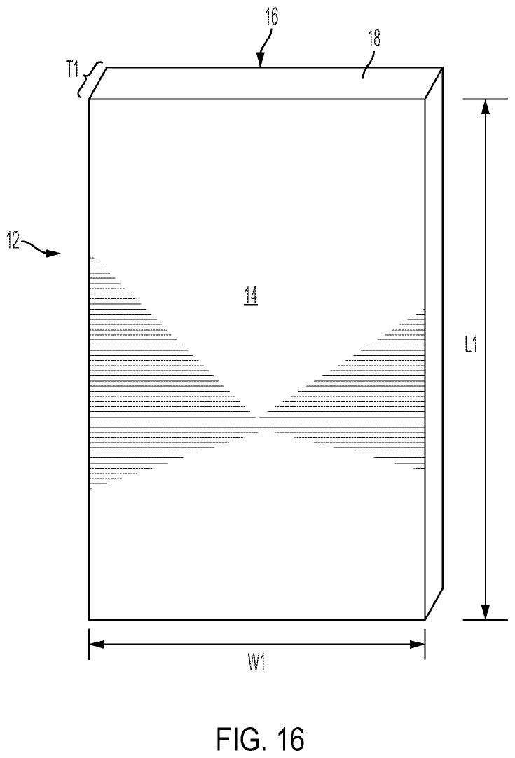

In the following paragraphs, various geometrical properties of the glass sheet 12 as well as compositions of the glass sheet are provided. Referring to FIG. 16, the glass sheet 12 has a thickness T1 that is substantially constant and is defined as a distance between the first major surface 14 and the second major surface 16. In various embodiments, T1 may refer to an average thickness or a maximum thickness of the glass sheet. In addition, the glass sheet 12 includes a width W1 defined as a first maximum dimension of one of the first or second major surfaces 14, 16 orthogonal to the thickness T1, and a length L1 defined as a second maximum dimension of one of the first or second major surfaces 14, 16 orthogonal to both the thickness and the width. In other embodiments, W1 and L1 may be the average width and the average length of the glass sheet 12, respectively, and in other embodiments, W1 and L1 may be the maximum width and the maximum length of the glass sheet 12, respectively (e.g., for glass sheets 14 having a variable width or length).

In various embodiments, thickness T1 is 2 mm or less and specifically is 0.3 mm to 1.1 mm. For example, thickness T1 may be in a range from about 0.1 mm to about 1.5 mm, from about 0.15 mm to about 1.5 mm, from about 0.2 mm to about 1.5 mm, from about 0.25 mm to about 1.5 mm, from about 0.3 mm to about 1.5 mm, from about 0.35 mm to about 1.5 mm, from about 0.4 mm to about 1.5 mm, from about 0.45 mm to about 1.5 mm, from about 0.5 mm to about 1.5 mm, from about 0.55 mm to about 1.5 mm, from about 0.6 mm to about 1.5 mm, from about 0.65 mm to about 1.5 mm, from about 0.7 mm to about 1.5 mm, from about 0.1 mm to about 1.4 mm, from about 0.1 mm to about 1.3 mm, from about 0.1 mm to about 1.2 mm, from about 0.1 mm to about 1.1 mm, from about 0.1 mm to about 1.05 mm, from about 0.1 mm to about 1 mm, from about 0.1 mm to about 0.95 mm, from about 0.1 mm to about 0.9 mm, from about 0.1 mm to about 0.85 mm, from about 0.1 mm to about 0.8 mm, from about 0.1 mm to about 0.75 mm, from about 0.1 mm to about 0.7 mm, from about 0.1 mm to about 0.65 mm, from about 0.1 mm to about 0.6 mm, from about 0.1 mm to about 0.55 mm, from about 0.1 mm to about 0.5 mm, from about 0.1 mm to about 0.4 mm, or from about 0.3 mm to about 0.7 mm. In other embodiments, the T1 falls within any one of the exact numerical ranges set forth in this paragraph.

In various embodiments, width W1 is in a range from 5 cm to 250 cm, from about 10 cm to about 250 cm, from about 15 cm to about 250 cm, from about 20 cm to about 250 cm, from about 25 cm to about 250 cm, from about 30 cm to about 250 cm, from about 35 cm to about 250 cm, from about 40 cm to about 250 cm, from about 45 cm to about 250 cm, from about 50 cm to about 250 cm, from about 55 cm to about 250 cm, from about 60 cm to about 250 cm, from about 65 cm to about 250 cm, from about 70 cm to about 250 cm, from about 75 cm to about 250 cm, from about 80 cm to about 250 cm, from about 85 cm to about 250 cm, from about 90 cm to about 250 cm, from about 95 cm to about 250 cm, from about 100 cm to about 250 cm, from about 110 cm to about 250 cm, from about 120 cm to about 250 cm, from about 130 cm to about 250 cm, from about 140 cm to about 250 cm, from about 150 cm to about 250 cm, from about 5 cm to about 240 cm, from about 5 cm to about 230 cm, from about 5 cm to about 220 cm, from about 5 cm to about 210 cm, from about 5 cm to about 200 cm, from about 5 cm to about 190 cm, from about 5 cm to about 180 cm, from about 5 cm to about 170 cm, from about 5 cm to about 160 cm, from about 5 cm to about 150 cm, from about 5 cm to about 140 cm, from about 5 cm to about 130 cm, from about 5 cm to about 120 cm, from about 5 cm to about 110 cm, from about 5 cm to about 110 cm, from about 5 cm to about 100 cm, from about 5 cm to about 90 cm, from about 5 cm to about 80 cm, or from about 5 cm to about 75 cm. In other embodiments, W1 falls within any one of the exact numerical ranges set forth in this paragraph.

In various embodiments, length L1 is in a range from about 5 cm to about 1500 cm, from about 50 cm to about 1500 cm, from about 100 cm to about 1500 cm, from about 150 cm to about 1500 cm, from about 200 cm to about 1500 cm, from about 250 cm to about 1500 cm, from about 300 cm to about 1500 cm, from about 350 cm to about 1500 cm, from about 400 cm to about 1500 cm, from about 450 cm to about 1500 cm, from about 500 cm to about 1500 cm, from about 550 cm to about 1500 cm, from about 600 cm to about 1500 cm, from about 650 cm to about 1500 cm, from about 650 cm to about 1500 cm, from about 700 cm to about 1500 cm, from about 750 cm to about 1500 cm, from about 800 cm to about 1500 cm, from about 850 cm to about 1500 cm, from about 900 cm to about 1500 cm, from about 950 cm to about 1500 cm, from about 1000 cm to about 1500 cm, from about 1050 cm to about 1500 cm, from about 1100 cm to about 1500 cm, from about 1150 cm to about 1500 cm, from about 1200 cm to about 1500 cm, from about 1250 cm to about 1500 cm, from about 1300 cm to about 1500 cm, from about 1350 cm to about 1500 cm, from about 1400 cm to about 1500 cm, or from about 1450 cm to about 1500 cm. In other embodiments, L1 falls within any one of the exact numerical ranges set forth in this paragraph.

In various embodiments, one or more radius of curvature (e.g., R shown in FIGS. 2A and 3A) of glass sheet 12 is about 20 mm or greater. For example, R may be in a range from about 20 mm to about 10,000 mm, from about 30 mm to about 10,000 mm, from about 40 mm to about 10,000 mm, from about 50 mm to about 10,000 mm, from about 60 mm to about 10,000 mm, from about 70 mm to about 10,000 mm, from about 80 mm to about 10,000 mm, from about 90 mm to about 10,000 mm, from about 100 mm to about 10,000 mm, from about 120 mm to about 10,000 mm, from about 140 mm to about 10,000 mm, from about 150 mm to about 10,000 mm, from about 160 mm to about 10,000 mm, from about 180 mm to about 10,000 mm, from about 200 mm to about 10,000 mm, from about 220 mm to about 10,000 mm, from about 240 mm to about 10,000 mm, from about 250 mm to about 10,000 mm, from about 260 mm to about 10,000 mm, from about 270 mm to about 10,000 mm, from about 280 mm to about 10,000 mm, from about 290 mm to about 10,000 mm, from about 300 mm to about 10,000 mm, from about 350 mm to about 10,000 mm, from about 400 mm to about 10,000 mm, from about 450 mm to about 10,000 mm, from about 500 mm to about 10,000 mm, from about 550 mm to about 10,000 mm, from about 600 mm to about 10,000 mm, from about 650 mm to about 10,000 mm, from about 700 mm to about 10,000 mm, from about 750 mm to about 10,000 mm, from about 800 mm to about 10,000 mm, from about 900 mm to about 10,000 mm, from about 950 mm to about 10,000 mm, from about 1000 mm to about 10,000 mm, from about 1250 mm to about 10,000 mm, from about 20 mm to about 1400 mm, from about 20 mm to about 1300 mm, from about 20 mm to about 1200 mm, from about 20 mm to about 1100 mm, from about 20 mm to about 1000 mm, from about 20 mm to about 950 mm, from about 20 mm to about 900 mm, from about 20 mm to about 850 mm, from about 20 mm to about 800 mm, from about 20 mm to about 750 mm, from about 20 mm to about 700 mm, from about 20 mm to about 650 mm, from about 20 mm to about 600 mm, from about 20 mm to about 550 mm, from about 20 mm to about 500 mm, from about 20 mm to about 450 mm, from about 20 mm to about 400 mm, from about 20 mm to about 350 mm, from about 20 mm to about 300 mm, or from about 20 mm to about 250 mm. In other embodiments, R1 falls within any one of the exact numerical ranges set forth in this paragraph.

The various embodiments of the vehicle interior system may be incorporated into vehicles such as trains, automobiles (e.g., cars, trucks, buses and the like), sea craft (boats, ships, submarines, and the like), and aircraft (e.g., drones, airplanes, jets, helicopters and the like).

### Strengthened Glass Properties

As noted above, glass sheet 12 may be strengthened. In one or more embodiments, glass sheet 12 may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In various embodiments, glass sheet 12 may be strengthened mechanically by utilizing a mismatch of the coefficient of thermal expansion between portions of the article to create a compressive stress region and a central region exhibiting a tensile stress. In some embodiments, the glass sheet may be strengthened thermally by heating the glass to a temperature above the glass transition point and then rapidly quenching.

In various embodiments, glass sheet 12 may be chemically strengthened by ion exchange. In the ion exchange process, ions at or near the surface of the glass sheet are replaced by—or exchanged with—larger ions having the same valence or oxidation state. In those embodiments in which the glass sheet comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass sheet generate a stress.

Ion exchange processes are typically carried out by immersing a glass sheet in a molten salt bath (or two or more molten salt baths) containing the larger ions to be exchanged with the smaller ions in the glass sheet. It should be noted that aqueous salt baths may also be utilized. In addition, the composition of the bath(s) may include more than one type of larger ions (e.g., Na+ and K+) or a single larger ion. It will be appreciated by those skilled in the art that parameters for the ion exchange process, including, but not limited to, bath composition and temperature, immersion time, the number of immersions of the glass sheet in a salt bath (or baths), use of multiple salt baths, additional steps such as annealing, washing, and the like, are generally determined by the composition of the glass sheet (including the structure of the article and any crystalline phases present) and the desired DOC and CS of the glass sheet that results from strengthening. Exemplary molten bath compositions may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass sheet thickness, bath temperature and glass (or monovalent ion) diffusivity. However, temperatures and immersion times different from those described above may also be used.

In one or more embodiments, the glass sheets may be immersed in a molten salt bath of 100% NaNO₃, 100% KNO₃, or a combination of NaNO₃ and KNO₃ having a temperature from about 370° C. to about 480° C. In some embodiments, the glass sheet may be immersed in a molten mixed salt bath including from about 5% to about 90% KNO₃ and from about 10% to about 95% NaNO₃. In one or more embodiments, the glass sheet may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass sheet may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass sheet. The spike may result in a greater surface CS value. This spike can be achieved by a single bath or multiple baths, with the bath(s) having a single composition or mixed composition, due to the unique properties of the glass compositions used in the glass sheets described herein.

In one or more embodiments, where more than one monovalent ion is exchanged into the glass sheet, the different monovalent ions may exchange to different depths within the glass sheet (and generate different magnitudes stresses within the glass sheet at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass sheet. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from Glasstress Ltd., located in Tallinn Estonia), depending on the strengthening method and conditions. When the glass sheet is chemically strengthened by an ion exchange treatment, FSM or SCALP may be used depending on which ion is exchanged into the glass sheet. Where the stress in the glass sheet is generated by exchanging potassium ions into the glass sheet, FSM is used to measure DOC. Where the stress is generated by exchanging sodium ions into the glass sheet, SCALP is used to measure DOC. Where the stress in the glass sheet is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass sheets is measured by FSM. Central tension or CT is the maximum tensile stress and is measured by SCALP.

In one or more embodiments, the glass sheet may be strengthened to exhibit a DOC that is described as a fraction of the thickness T1 of the glass sheet 12 (as described herein). For example, in one or more embodiments, the DOC may be equal to or greater than about 0.05T1, equal to or greater than about 0.1T1, equal to or greater than about 0.11T1, equal to or greater than about 0.12T1, equal to or greater than about 0.13T1, equal to or greater than about 0.14T1, equal to or greater than about 0.15T1, equal to or greater than about 0.16T1, equal to or greater than about 0.17T1, equal to or greater than about 0.18T1, equal to or greater than about 0.19T1, equal to or greater than about 0.2T1, equal to or greater than about 0.21T1. In some embodiments, the DOC may be in a range from about 0.08T1 to about 0.25T1, from about 0.09T1 to about 0.25T1, from about 0.18T1 to about 0.25T1, from about 0.11T1 to about 0.25T1, from about 0.12T1 to about 0.25T1, from about 0.13T1 to about 0.25T1, from about 0.14T1 to about 0.25T1, from about 0.15T1 to about 0.25T1, from about 0.08T1 to about 0.24T1, from about 0.08T1 to about 0.23T1, from about 0.08T1 to about 0.22T1, from about 0.08T1 to about 0.21T1, from about 0.08T1 to about 0.2T1, from about 0.08T1 to about 0.19T1, from about 0.08T1 to about 0.18T1, from about 0.08T1 to about 0.17T1, from about 0.08T1 to about 0.16T1, or from about 0.08T1 to about 0.15T1. In some instances, the DOC may be about 20 μm or less. In one or more embodiments, the DOC may be about 40 μm or greater (e.g., from about 40 μm to about 300 μm, from about 50 μm to about 300 μm, from about 60 μm to about 300 μm, from about 70 μm to about 300 μm, from about 80 μm to about 300 μm, from about 90 μm to about 300 μm, from about 100 μm to about 300 μm, from about 110 μm to about 300 μm, from about 120 μm to about 300 μm, from about 140 μm to about 300 μm, from about 150 μm to about 300 μm, from about 40 μm to about 290 μm, from about 40 μm to about 280 μm, from about 40 μm to about 260 μm, from about 40 μm to about 250 μm, from about 40 μm to about 240 μm, from about 40 μm to about 230 μm, from about 40 μm to about 220 μm, from about 40 μm to about 210 μm, from about 40 μm to about 200 μm, from about 40 μm to about 180 μm, from about 40 μm to about 160 μm, from about 40 μm to about 150 μm, from about 40 μm to about 140 μm, from about 40 μm to about 130 μm, from about 40 μm to about 120 μm, from about 40 μm to about 110 μm, or from about 40 μm to about 100 μm. In other embodiments, DOC falls within any one of the exact numerical ranges set forth in this paragraph.

In one or more embodiments, the strengthened glass sheet may have a CS (which may be found at the surface or a depth within the glass sheet) of about 200 MPa or greater, 300 MPa or greater, 400 MPa or greater, about 500 MPa or greater, about 600 MPa or greater, about 700 MPa or greater, about 800 MPa or greater, about 900 MPa or greater, about 930 MPa or greater, about 1000 MPa or greater, or about 1050 MPa or greater.

In one or more embodiments, the strengthened glass sheet may have a maximum tensile stress or central tension (CT) of about 20 MPa or greater, about 30 MPa or greater, about 40 MPa or greater, about 45 MPa or greater, about 50 MPa or greater, about 60 MPa or greater, about 70 MPa or greater, about 75 MPa or greater, about 80 MPa or greater, or about 85 MPa or greater. In some embodiments, the maximum tensile stress or central tension (CT) may be in a range from about 40 MPa to about 100 MPa. In other embodiments, CS falls within the exact numerical ranges set forth in this paragraph.

### Glass Compositions

Suitable glass compositions for use in glass sheet 12 include soda lime glass, aluminosilicate glass, borosilicate glass, boroaluminosilicate glass, alkali-containing aluminosilicate glass, alkali-containing borosilicate glass, and alkali-containing boroaluminosilicate glass.

Unless otherwise specified, the glass compositions disclosed herein are described in mole percent (mol %) as analyzed on an oxide basis.

In one or more embodiments, the glass composition may include Sift in an amount in a range from about 66 mol % to about 80 mol %, from about 67 mol % to about 80 mol %, from about 68 mol % to about 80 mol %, from about 69 mol % to about 80 mol %, from about 70 mol % to about 80 mol %, from about 72 mol % to about 80 mol %, from about 65 mol % to about 78 mol %, from about 65 mol % to about 76 mol %, from about 65 mol % to about 75 mol %, from about 65 mol % to about 74 mol %, from about 65 mol % to about 72 mol %, or from about 65 mol % to about 70 mol %, and all ranges and sub-ranges therebetween.

In one or more embodiments, the glass composition includes Al₂O₃ in an amount greater than about 4 mol %, or greater than about 5 mol %. In one or more embodiments, the glass composition includes Al₂O₃ in a range from greater than about 7 mol % to about 15 mol %, from greater than about 7 mol % to about 14 mol %, from about 7 mol % to about 13 mol %, from about 4 mol % to about 12 mol %, from about 7 mol % to about 11 mol %, from about 8 mol % to about 15 mol %, from about 9 mol % to about 15 mol %, from about 10 mol % to about 15 mol %, from about 11 mol % to about 15 mol %, or from about 12 mol % to about 15 mol %, and all ranges and sub-ranges therebetween. In one or more embodiments, the upper limit of Al₂O₃ may be about 14 mol %, 14.2 mol %, 14.4 mol %, 14.6 mol %, or 14.8 mol %.

In one or more embodiments, the glass article is described as an aluminosilicate glass article or including an aluminosilicate glass composition. In such embodiments, the glass composition or article formed therefrom includes SiO₂ and Al₂O₃ and is not a soda lime silicate glass. In this regard, the glass composition or article formed therefrom includes Al₂O₃ in an amount of about 2 mol % or greater, 2.25 mol % or greater, 2.5 mol % or greater, about 2.75 mol % or greater, about 3 mol % or greater.

In one or more embodiments, the glass composition comprises B₂O₃ (e.g., about 0.01 mol % or greater). In one or more embodiments, the glass composition comprises B₂O₃ in an amount in a range from about 0 mol % to about 5 mol %, from about 0 mol % to about 4 mol %, from about 0 mol % to about 3 mol %, from about 0 mol % to about 2 mol %, from about 0 mol % to about 1 mol %, from about 0 mol % to about 0.5 mol %, from about 0.1 mol % to about 5 mol %, from about 0.1 mol % to about 4 mol %, from about 0.1 mol % to about 3 mol %, from about 0.1 mol % to about 2 mol %, from about 0.1 mol % to about 1 mol %, from about 0.1 mol % to about 0.5 mol %, and all ranges and sub-ranges therebetween. In one or more embodiments, the glass composition is substantially free of B₂O₃.

As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P₂O₅ (e.g., about 0.01 mol % or greater). In one or more embodiments, the glass composition comprises a non-zero amount of P₂O₅ up to and including 2 mol %, 1.5 mol %, 1 mol %, or 0.5 mol %. In one or more embodiments, the glass composition is substantially free of P₂O₅.

In one or more embodiments, the glass composition may include a total amount of R₂O (which is the total amount of alkali metal oxide such as Li₂O, Na₂O, K₂O, Rb₂O, and Cs₂O) that is greater than or equal to about 8 mol %, greater than or equal to about 10 mol %, or greater than or equal to about 12 mol %. In some embodiments, the glass composition includes a total amount of R₂O in a range from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 13 mol %, and all ranges and sub-ranges therebetween. In one or more embodiments, the glass composition may be substantially free of Rb₂O, Cs₂O or both Rb₂O and Cs₂O. In one or more embodiments, the R₂O may include the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount greater than or equal to about 8 mol %, greater than or equal to about 10 mol %, or greater than or equal to about 12 mol %. In one or more embodiments, the composition includes Na₂O in a range from about from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 16 mol %, and all ranges and sub-ranges therebetween.

In one or more embodiments, the glass composition includes less than about 4 mol % K₂O, less than about 3 mol % K₂O, or less than about 1 mol % K₂O. In some instances, the glass composition may include K₂O in an amount in a range from about 0 mol % to about 4 mol %, from about 0 mol % to about 3.5 mol %, from about 0 mol % to about 3 mol %, from about 0 mol % to about 2.5 mol %, from about 0 mol % to about 2 mol %, from about 0 mol % to about 1.5 mol %, from about 0 mol % to about 1 mol %, from about 0 mol % to about 0.5 mol %, from about 0 mol % to about 0.2 mol %, from about 0 mol % to about 0.1 mol %, from about 0.5 mol % to about 4 mol %, from about 0.5 mol % to about 3.5 mol %, from about 0.5 mol % to about 3 mol %, from about 0.5 mol % to about 2.5 mol %, from about 0.5 mol % to about 2 mol %, from about 0.5 mol % to about 1.5 mol %, or from about 0.5 mol % to about 1 mol %, and all ranges and sub-ranges therebetween. In one or more embodiments, the glass composition may be substantially free of K₂O.

In one or more embodiments, the glass composition is substantially free of Li₂O.

In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may include a total amount of RO (which is the total amount of alkaline earth metal oxide such as CaO, MgO, BaO, ZnO and SrO) in a range from about 0 mol % to about 2 mol %. In some embodiments, the glass composition includes a non-zero amount of RO up to about 2 mol %. In one or more embodiments, the glass composition comprises RO in an amount from about 0 mol % to about 1.8 mol %, from about 0 mol % to about 1.6 mol %, from about 0 mol % to about 1.5 mol %, from about 0 mol % to about 1.4 mol %, from about 0 mol % to about 1.2 mol %, from about 0 mol % to about 1 mol %, from about 0 mol % to about 0.8 mol %, from about 0 mol % to about 0.5 mol %, and all ranges and sub-ranges therebetween.

In one or more embodiments, the glass composition includes CaO in an amount less than about 1 mol %, less than about 0.8 mol %, or less than about 0.5 mol %. In one or more embodiments, the glass composition is substantially free of CaO.

In some embodiments, the glass composition comprises MgO in an amount from about 0 mol % to about 7 mol %, from about 0 mol % to about 6 mol %, from about 0 mol % to about 5 mol %, from about 0 mol % to about 4 mol %, from about 0.1 mol % to about 7 mol %, from about 0.1 mol % to about 6 mol %, from about 0.1 mol % to about 5 mol %, from about 0.1 mol % to about 4 mol %, from about 1 mol % to about 7 mol %, from about 2 mol % to about 6 mol %, or from about 3 mol % to about 6 mol %, and all ranges and sub-ranges therebetween.

In one or more embodiments, the glass composition comprises ZrO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises ZrO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition comprises SnO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises SnO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition may include an oxide that imparts a color or tint to the glass articles. In some embodiments, the glass composition includes an oxide that prevents discoloration of the glass article when the glass article is exposed to ultraviolet radiation. Examples of such oxides include, without limitation oxides of: Ti, V, Cr, Mn, Fe, Co, Ni, Cu, Ce, W, and Mo.

In one or more embodiments, the glass composition includes Fe expressed as Fe₂O₃, wherein Fe is present in an amount up to (and including) about 1 mol %. In some embodiments, the glass composition is substantially free of Fe. In one or more embodiments, the glass composition comprises Fe₂O₃ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises Fe₂O₃ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

Where the glass composition includes TiO₂, TiO₂ may be present in an amount of about 5 mol % or less, about 2.5 mol % or less, about 2 mol % or less or about 1 mol % or less. In one or more embodiments, the glass composition may be substantially free of TiO₂.

An exemplary glass composition includes SiO₂ in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1.5 mol % to about 6 mol %. Optionally, SnO₂ may be included in the amounts otherwise disclosed herein. It should be understood, that while the preceding glass composition paragraphs express approximate ranges, in other embodiments, glass sheet 12 may be made from any glass composition falling with any one of the exact numerical ranges discussed above.

Aspect (1) of this disclosure pertains to a curved glass article, comprising: a glass sheet comprising a first major surface and a second major surface, the second major surface being opposite to the first major surface, wherein the first major surface and the second major surface define a thickness therebetween; a carrier comprising a curvature and a carrier material, the carrier material having a coefficient of thermal expansion (CTE) of from 8(10⁻⁶)/° C. to 40(10⁻⁶)/° C.; wherein the glass sheet is adhered to the carrier such that the glass sheet conforms to the curvature of the carrier.

Aspect (2) of this disclosure pertains to the curved glass article of Aspect (1), wherein carrier comprises a first strip along a first lateral side of the glass sheet and a second strip along a second lateral side of the glass sheet.

Aspect (3) of this disclosure pertains to the curved glass article of Aspect (2), wherein the carrier further comprises at least one reinforcing strip extending from the first strip to the second strip.

Aspect (4) of this disclosure pertains to the curved glass article of any one of Aspects (1) through (3), wherein the carrier material is a steel alloy.

Aspect (5) of this disclosure pertains to the curved glass article of Aspect (4), wherein the steel alloy is a stainless steel alloy or a galvanized steel alloy.

Aspect (6) of this disclosure pertains to the curved glass article of an one of Aspects (1) through (3), wherein the carrier material is a fiber-reinforced composite.

Aspect (7) of this disclosure pertains to the curved glass article of Aspect (6), wherein the fiber-reinforced composite comprises at least one of carbon fibers, glass fibers, aramid fibers, or graphite fibers, and wherein the fiber-reinforced composite comprises at least one of epoxy resin, polycarbonate, acrylic, polyester, polyetherketoneketone, polycarbonate/acrylonitrile butadiene styrene, polypropylene, or phenolic resin.

Aspect (8) of this disclosure pertains to the curved glass article of Aspect (7), wherein the fiber reinforced composite comprises glass fibers and an epoxy resin and wherein the glass fibers comprise a volume fraction of 0.38 to 0.52 of the fiber-reinforced composite.

Aspect (9) of this disclosure pertains to the curved glass article of any one of Aspects (1) through (8), wherein the curved glass article is V-shaped.

Aspect (10) of this disclosure pertains to the curved glass article of any one of Aspects (1) through (8), wherein the curved glass article is C-shaped.

Aspect (11) of this disclosure pertains to the curved glass article of any one of Aspects (1) through (10), wherein the curvature has a radius of from 20 mm to 10,000 mm.

Aspect (12) of this disclosure pertains to the curved glass article of any one of Aspects (1) through (11), wherein the glass sheet comprises at least one of soda lime glass, aluminosilicate glass, borosilicate glass, boroaluminosilicate glass, alkali-containing aluminosilicate glass, alkali-containing borosilicate glass, and alkali-containing boroaluminosilicate glass.

Aspect (13) of this disclosure pertains to the curved glass article of any one of Aspects (1) through (12), wherein the glass sheet has a thickness of from 0.4 mm to 2.0 mm.

Aspect (14) of this disclosure pertains to the curved glass article of any one of Aspects (1) through (13), wherein at least one of the first major surface or the second major surface comprises a surface treatment.

Aspect (15) of this disclosure pertains to the curved glass article of Aspect (14), wherein the surface treatment is at least one of a tint film, a pigment design, an anti-glare treatment, an anti-reflective coating, and easy-to-clean coating.

Aspect (16) of this disclosure pertains to the curved glass article of any one of Aspects (1) through (15), wherein the carrier comprises a segmented strip adhered to at least at least one lateral side of the glass sheet.

Aspect (17) of this disclosure pertains to the curved glass article of Aspect (16), wherein the segmented strip includes a plurality of detents configured to connect the carrier to a frame of a vehicle interior system and a plurality of bonding surfaces adhered to the second major surface of the glass sheet and wherein the segmented strip defines a zigzag structure along its length.

Aspect (18) of this disclosure pertains to the curved glass article of Aspect (16), wherein the segmented strip includes a hook member configured to connect the carrier to a frame of a vehicle interior system, a plurality of bonding surfaces adhered to the second major surface of the glass sheet, and a plurality of slots periodically spaced along the length of the segmented strip.

Aspect (19) of this disclosure pertains to the curved glass article of any one of Aspects (1) through (15), wherein the carrier comprises at least one strip having a bonding surface adhered to the second major surface of the glass sheet and a mounting surface comprising a plurality of apertures configured to receive fasteners that join the carrier to a frame of a vehicle interior system and wherein the mounting surface is arranged substantially perpendicularly to the bonding surface.

Aspect (20) of this disclosure pertains to the curved glass article of any one of Aspects (1) through (19), further comprising at least one display mounted to the second major surface of the glass sheet.

Aspect (21) of this disclosure pertains to the curved glass article of Aspect (20), wherein the at least one display comprises at least one of an light-emitting diode display, an organic light-emitting diode display, a liquid crystal display, or plasma display.

Aspect (22) of this disclosure pertains to a curved glass article, comprising:

a glass sheet comprising a first major surface and a second major surface, the second major surface being opposite to the first major surface, wherein the first major surface and the second major surface define a thickness therebetween; a carrier comprising a curvature; an adhesive bonding the second major surface of the glass sheet to the carrier such that the glass sheet conforms to the curvature of the carrier; wherein the adhesive has a bonding strength; and wherein a combined stress includes a bending stress to conform the glass sheet to the curvature and a shear stress caused by a differential in expansion resulting from heating the glass sheet and carrier up by 75° from room temperature; and wherein the combined stress is less than the bonding strength.

Aspect (23) pertains to the curved glass article of Aspect (22), wherein the combined stress is no more than 1.4 MPa.

Aspect (24) pertains to the curved glass article of Aspect (22) or Aspect (23), wherein the bonding strength is at most 0.6 MPa.

Aspect (25) of this disclosure pertains to the curved glass article of any one of Aspects (22) through (24), wherein the carrier comprises a carrier material having a coefficient of thermal expansion of from 8(10⁻⁶)/° C. to 40(10⁻⁶)/° C.

Aspect (26) of this disclosure pertains to the curved glass article of Aspect (25), wherein the carrier material is a steel alloy.

Aspect (27) of this disclosure pertains to the curved glass article of Aspect (25), wherein the carrier material is one of an iron-nickel alloy, aluminum and its alloys, or magnesium and its alloys.

Aspect (28) of this disclosure pertains to the curved glass article of Aspect (25), wherein the steel alloy is a stainless steel alloy or a galvanized steel alloy.

Aspect (29) of this disclosure pertains to the curved glass article of Aspect (25), wherein the carrier material is a fiber-reinforced composite.

Aspect (30) of this disclosure pertains to the curved glass article of Aspect (29),3 wherein the fiber-reinforced composite comprises at least one of carbon fibers, glass fibers, aramid fibers, or graphite fibers and wherein the fiber-reinforced composite comprises at least one of epoxy resin, polycarbonate, acrylic, polyester, polyetherketoneketone, polycarbonate/acrylonitrile butadiene styrene, polypropylene, or phenolic resin.

Aspect (31) of this disclosure pertains to the curved glass article of Aspect (30), wherein the fiber reinforced composite comprises glass fibers and an epoxy resin and wherein the glass fibers comprise a volume fraction of from 0.38 to 0.52 of the fiber-reinforced composite.

Aspect (32) of this disclosure pertains to the curved glass article of any one of Aspects (22) through (31), wherein the curved glass article is V-shaped.

Aspect (33) of this disclosure pertains to the curved glass article of any one of Aspects (22) through (31), wherein the curved glass article is C-shaped.

Aspect (34) of this disclosure pertains to the curved glass article of any one of Aspects (22) through (33), wherein the curvature has a radius of from 20 mm to 10,000 mm.

Aspect (35) of this disclosure pertains to the curved glass article of any one of Aspects (22) through (34), wherein the glass sheet comprises at least one of soda lime glass, aluminosilicate glass, borosilicate glass, boroaluminosilicate glass, alkali-containing aluminosilicate glass, alkali-containing borosilicate glass, and alkali-containing boroaluminosilicate glass.

Aspect (36) of this disclosure pertains to the curved glass article of any one of Aspects (22) through (35), wherein the glass sheet has a thickness of from 0.4 mm to 2.0 mm.

Aspect (37) of this disclosure pertains to the curved glass article of any one of Aspects (22) through (36), wherein at least one of the first major surface or the second major surface comprises a surface treatment.

Aspect (38) of this disclosure pertains to the curved glass article of Aspect (37), wherein the surface treatment is at least one of a tint film, a pigment design, an anti-glare treatment, an anti-reflective coating, and easy-to-clean coating.

Aspect (39) of this disclosure pertains to the curved glass article of any one of Aspects (22) through (38), wherein the carrier comprises a segmented strip adhered to at least at least one lateral side of the glass sheet.

Aspect (40) of this disclosure pertains to the curved glass article of any one of Aspects (22) through (39), wherein the segmented strip includes a plurality of detents configured to connect the carrier to a frame of a vehicle interior system and a plurality of bonding surfaces adhered to the second major surface of the glass sheet and wherein the segmented strip defines a zigzag structure along its length.

Aspect (41) of this disclosure pertains to the curved glass article of Aspect (39), wherein the segmented strip includes a hook member configured to connect the carrier to a frame of a vehicle interior system, a plurality of bonding surfaces adhered to the second major surface of the glass sheet, and a plurality of slots periodically spaced along the length of the segmented strip.

Aspect (42) of this disclosure pertains to the curved glass article of any one of Aspects (22) through (41), wherein the carrier comprises at least one strip having a bonding surface adhered to the second major surface of the glass sheet and a mounting surface comprising a plurality of apertures configured to receive fasteners that join the carrier to a frame of a vehicle interior system and wherein the mounting surface is arranged substantially perpendicularly to the bonding surface.

Aspect (43) of this disclosure pertains to the curved glass article of any one of Aspects (22) through (42), further comprising at least one display mounted to the second major surface of the glass sheet.

Aspect (44) of this disclosure pertains to the curved glass article of Aspect (43), wherein the at least one display comprises at least one of an light-emitting diode display, an organic light-emitting diode display, a liquid crystal display, or plasma display.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A curved glass article, comprising:
a glass sheet comprising a first major surface and a second major surface, the second major surface being opposite to the first major surface, wherein the first major surface and the second major surface define a thickness therebetween;
a carrier comprising a curvature and a carrier material, the carrier material having a coefficient of thermal expansion (CTE) of from 8(10⁻⁶)/° C. to 40(10⁻⁶)/° C.;
wherein the glass sheet is adhered to the carrier such that the glass sheet conforms to the curvature of the carrier.

2. The curved glass article of claim 1, wherein carrier comprises a first strip along a first lateral side of the glass sheet and a second strip along a second lateral side of the glass sheet.

3. The curved glass article of claim 2, wherein the carrier further comprises at least one reinforcing strip extending from the first strip to the second strip.

4. The curved glass article claim 1, wherein the carrier material is a steel alloy.

5. (canceled)

6. The curved glass article claim 1, wherein the carrier material is a fiber-reinforced composite.

7. The curved glass article of claim 6, wherein the fiber-reinforced composite comprises at least one of carbon fibers, glass fibers, aramid fibers, or graphite fibers, and wherein the fiber-reinforced composite comprises at least one of epoxy resin, polycarbonate, acrylic, polyester, polyetherketoneketone, polycarbonate/acrylonitrile butadiene styrene, polypropylene, or phenolic resin.

8. The curved glass article of claim 7, wherein the fiber reinforced composite comprises glass fibers and an epoxy resin and wherein the glass fibers comprise a volume fraction of 0.38 to 0.52 of the fiber-reinforced composite.

9. (canceled)

10. (canceled)

11. (canceled)

12. (canceled)

13. (canceled)

14. (canceled)

15. (canceled)

16. The curved glass article of claim 1, wherein the carrier comprises a segmented strip adhered to at least at least one lateral side of the glass sheet.

17. The curved glass article of claim 16, wherein the segmented strip includes a plurality of detents configured to connect the carrier to a frame of a vehicle interior system and a plurality of bonding surfaces adhered to the second major surface of the glass sheet and wherein the segmented strip defines a zigzag structure along its length.

18. The curved glass article of claim 16, wherein the segmented strip includes a hook member configured to connect the carrier to a frame of a vehicle interior system, a plurality of bonding surfaces adhered to the second major surface of the glass sheet, and a plurality of slots periodically spaced along the length of the segmented strip.

19. The curved glass article of claim 1, wherein the carrier comprises at least one strip having a bonding surface adhered to the second major surface of the glass sheet and a mounting surface comprising a plurality of apertures configured to receive fasteners that join the carrier to a frame of a vehicle interior system and wherein the mounting surface is arranged substantially perpendicularly to the bonding surface.

20. (canceled)

21. (canceled)

22. A curved glass article, comprising:
a glass sheet comprising a first major surface and a second major surface, the second major surface being opposite to the first major surface, wherein the first major surface and the second major surface define a thickness therebetween;
a carrier comprising a curvature;
an adhesive bonding the second major surface of the glass sheet to the carrier such that the glass sheet conforms to the curvature of the carrier;
wherein the adhesive has a bonding strength; and
wherein a combined stress includes a bending stress to conform the glass sheet to the curvature and a shear stress caused by a differential in expansion resulting from heating the glass sheet and carrier up by 75° from room temperature; and
wherein the combined stress is less than the bonding strength.

23. The curved glass article of claim 22, wherein the combined stress is no more than 1.4 MPa.

24. The curved glass article of claim 22, wherein the bonding strength is at most 0.6 MPa.

25. The curved glass article according to claim 22, wherein the carrier comprises a carrier material having a coefficient of thermal expansion of from 8(10⁻⁶)/° C. to 40(10⁻⁶)/° C.

26. (canceled)

27. (canceled)

28. (canceled)

29. The curved glass article of claim 25, wherein the carrier material is a fiber-reinforced composite, wherein the fiber-reinforced composite comprises at least one of carbon fibers, glass fibers, aramid fibers, or graphite fibers and wherein the fiber-reinforced composite comprises at least one of epoxy resin, polycarbonate, acrylic, polyester, polyetherketoneketone, polycarbonate/acrylonitrile butadiene styrene, polypropylene, or phenolic resin.

30. (canceled)

31. The curved glass article of claim 29, wherein the fiber reinforced composite comprises glass fibers and an epoxy resin and wherein the glass fibers comprise a volume fraction of from 0.38 to 0.52 of the fiber-reinforced composite.

32. (canceled)

33. (canceled)

34. (canceled)

35. (canceled)

36. (canceled)

37. (canceled)

38. (canceled)

39. (canceled)

40. The curved glass article of claim 22, wherein the carrier comprises a segmented strip adhered to at least at least one lateral side of the glass sheet, wherein the segmented strip includes a plurality of detents configured to connect the carrier to a frame of a vehicle interior system and a plurality of bonding surfaces adhered to the second major surface of the glass sheet and wherein the segmented strip defines a zigzag structure along its length.

41. The curved glass article of claim 22, wherein the carrier comprises a segmented strip adhered to at least at least one lateral side of the glass sheet, wherein the segmented strip includes a hook member configured to connect the carrier to a frame of a vehicle interior system, a plurality of bonding surfaces adhered to the second major surface of the glass sheet, and a plurality of slots periodically spaced along the length of the segmented strip.

42. The curved glass article according to claim 22, wherein the carrier comprises at least one strip having a bonding surface adhered to the second major surface of the glass sheet and a mounting surface comprising a plurality of apertures configured to receive fasteners that join the carrier to a frame of a vehicle interior system and wherein the mounting surface is arranged substantially perpendicularly to the bonding surface.

43. (canceled)

44. (canceled)
